(19) United States
(12) Patent Application Publication
(10) Pub. No.: US 2005/0160941 A1
(43) Pub. Date: Jul. 28, 2005

(54) Moisture resistant coating for composites and components

(75) Inventor: Longin B. Greszczuk, Mission Viejo, CA (US)

Correspondence Address: Shaukat A. Karjeker;Steiner Norris PLLC, 2320 2nd Avenue, Suite 2000, Seattle, WA, 98121, US

(73) Assignee: The Boeing Company, Chicago, IL (US)

(21) Appl. No.: 10/766,702

(22) Filed: Jan. 28, 2004

(51) Int. Cl. C09D 4/00

(52) U.S. Cl. 106/272; 106/243; 106/285

(57) ABSTRACT

A coating composition resistant to penetration by moisture, the composition substantially preventing moisture absorption into a substrate, such as a composite or core material used in a sandwich composite structure, that is otherwise prone to moisture absorption under “hot and wet” ambient conditions. The composition includes: a) a mixture of esters of fatty acids and aliphatic hydrocarbons having a melting point in the range from about 170 to about 190° F.; and b) a powdered additive in sufficient amount to permit uniform heating of a mass of the composition and to provide compression of a mass of the composition upon rapid cooling sufficient to substantially exclude occluded gasses from a cooled mass.

### BACKGROUND OF THE INVENTION

1. Field of the Invention

The invention relates to the field of coatings, and more particularly to the coating of materials prone to moisture absorption.

2. Description of the Related Art

Advanced lightweight structures made with composite materials are becoming increasingly important in a variety of applications, as processes for manufacture improve and as properties of these materials are better understood, and hence more readily customized for particular uses. Composites generally include a solid material (a filler or reinforcement that could be particulate, fibrous, or a woven or nonwoven oriented or non-oriented fiber material, etc.) incorporated into a matrix that most typically is an organic polymer. Additives of various kinds may be added to serve a variety of functions. Composites may form outer layers of a sandwich structure in which the inner core may be material such as foam or a lightweight core, such as honeycomb core, to form a structured composite product.

In its simplest aspect, engineering the properties of the composite depends upon appropriate selection of the reinforcement material and the matrix material. In a structured product, the core must also be carefully selected for the intended purpose of the product.

Engineered composites are used in the aerospace industry in a variety of structural applications, and are also finding use in other areas, for example the automobile and boat building industries, because they can be made lightweight, strong, and durable. Depending upon the nature of its use, the composite may be subject to harsh environmental conditions of temperature and humidity. Accordingly, it is desirable that the composite resist environmental effects and retain its mechanical properties.

### SUMMARY OF THE INVENTION

The invention provides a coating composition that, when applied to composites, foams, honeycomb, or other materials, effectively resists moisture penetration into these materials under ambient conditions of temperature, pressure and humidity.

In one embodiment, the coating composition of the invention substantially prevents moisture absorption into the material that is otherwise subject to moisture absorption under conditions of high ambient temperature and humidity. This composition includes:
(a) a mixture of aliphatic hydrocarbons and esters of fatty acids, the mixture having a melting point in the range from about 120° F. (about 50° C.) to about 250° F. (about 120° C.); and
(b) a powdered additive in sufficient amount to make the composition a rigid solid at ambient temperature, the amount of additive sufficient to permit rapid uniform heating of a mass of the composition, and during cooling of the liquid mass to a solid, the additive sufficient to provide compression of the mass to substantially exclude occluded gasses from the cooled mass.

The composition, in one embodiment, is a solid at ambient temperatures. However, it may be heated to liquefaction for ease of application as a coating to a substrate by spraying, by means of a roller or brush, or by other means ordinarily used to apply coatings.

The coatings of the invention preferably do not include solvents, and therefore do not pose environmental issues raised by evaporation of solvent (usually a volatile organic compound) into the atmosphere. The coatings of the invention are stable and long-lived, but they can be removed by application of heat to melt off the coatings, or a suitable solvent to dissolve the coatings, should the need arise. The coating compositions of the invention are non corrosive to typical composite and core materials, and so do not in themselves pose any hazards with respect to their physical properties. Relatively thin coatings are effective in preventing moisture absorption, and so the coatings do not appreciably add weight to structure where weight is an important factor.

The foregoing represents a brief summary of advantages and features of the invention that is detailed in the discussion here below and from which a person of skill in the art will readily appreciate additional benefits and features of the invention.

### BRIEF DESCRIPTION OF THE DRAWINGS

The following illustrative diagrams are intended to facilitate an understanding of the invention. The diagrams do not limit the scope of the invention, which is demarcated solely in the claims here below.

FIG. 1 is a graphical representation of test data comparing the efficacy of an embodiment of the coatings in accordance with the invention in resisting moisture penetration into ROHACELL™ brand foam as compared to a commercial coating and as compared to an uncoated control;

FIG. 2 is a graphical representation of test data comparing the efficacy of an embodiment of the coatings in accordance with the invention in resisting moisture penetration into fibrous composite as compared to a composite coated with a commercial coating and an uncoated control.

The foregoing diagrams should be understood in light of the more detailed description of embodiments of the invention provided in the following section.

### DETAILED DESCRIPTION OF THE PREFERRED EMBODIMENTS

Composites usually include a filler embedded in or coated with a matrix of an organic polymer or mixtures of polymers. The filler could be selected from powdered filler, fibrous filler, woven filler, non-woven filler, oriented fiber filler, and many other types available commercially. Other additives may be added for a variety of purposes, for example ultra violet inhibitors to retard ultraviolet light induced degradation of the composite matrix, color additives for aesthetic or other reasons, catalysts to facilitate cross linking of the matrix, and other additives for other purposes. The filler and matrix are selected to be compatible with each other and to provide desired physical properties. Composites may be fabricated into structural composites that include more than one type of material. For example, a structural composite might include a “sandwich” construction with outer thin layers of a composite covering a core of another material, such as a structured cellular material or a foam or balsa wood. Such lightweight composite materials can be used in a variety of applications, for example, aircraft cabin luggage bins, automobile interior panels, fairings for rocket launch vehicles, ship structures, airplane wings, and the like. However, it has been found that composites and certain sandwich core materials tend to suffer an often dramatic reduction in mechanical properties when they are exposed to hot and humid or wet ambient air conditions. The term “hot and humid ambient conditions” as used herein means conditions of temperature and humidity typically encountered world wide, and includes temperatures in the range from about 32° F. (about 0° C.) to about 125° F. (about 51° C.) and relative humidities of from about 30 to about 100%.

The deterioration of mechanical properties has been linked to moisture absorption from surroundings. The combined effects of temperature and humidity result in an increase in moisture content of the material (both outer layers and core in the case of structural composites) up to an equilibrium moisture content for the particular temperature and humidity conditions, over a period of time. The time period for equilibration of moisture content varies, based on the type of material, the temperature and the relative humidity. Regardless of time, however, the absorption of moisture significantly degrades mechanical properties as moisture content increases, and presents a challenge in applications where certain mechanical properties must meet specifications. In some instances, composite structures are subjected to a low humidity environment, and controlled temperatures to “drive out” the moisture absorbed into the structure, over a period of time, often measured in days. Removing the moisture may restore the mechanical properties, and so the deleterious effects of moisture absorption may be reversible. This attempted solution is often not practical and is both costly and time consuming. And, indeed, after the structure is removed from the controlled environment and returned to wet and hot ambient conditions, moisture absorption recommences.

The invention resolves the moisture absorption problem by providing a coating composition that minimizes and virtually completely prevents absorption of moisture into a substrate, including for example, a composite, and/or its inner core material. As a result, in the case of a composite, it maintains its mechanical properties virtually unchanged, despite prolonged exposure to hot and wet ambient conditions.

The composition in accordance with the invention includes a polymer mixture that includes hydrophobic organic compounds. More particularly, in one embodiment, these compounds are esters of fatty acids and aliphatic hydrocarbons, and an inorganic powder additive. Preferably, but not necessarily, the mixture of waxes and aliphatic hydrocarbons has a melting point in the range from about 120° F. (50° C.) to about 250° F. (120° C.), and more preferably from about 170° F. (77° C.) to about 190° F. (88° C.). Preferably, but not necessarily, the mixture is a relatively rigid stable solid at room temperature (about 75° F. or 24° C.).

In one embodiment, the fatty acids include waxes in the range of chain lengths typical of beeswax; and the aliphatic hydrocarbons include paraffins, primarily of carbon chain length C18 to C36, although other carbon chain lengths might also be present in smaller proportion.

An embodiment of the polymer mixture may be prepared by combining, in suitable proportions, components A and B, where A is yellow bees wax sold by Freeman Manufacturing & Supply of USA, and B is a Paraffin sold by Eastman Kodak of USA. In this embodiment the ratio of A to B may vary from about 90:10 to about 10:90; but preferably about 70:30 to about 30:70 and most preferably, about 60 to about 40.

It has been found that a powdered inorganic material must be added to the mixture of aliphatic hydrocarbons to perform a function. Preferably, the powder is selected from powdered metal or metal oxide. The powdered material must be compatible with the polymers of the mixture, and have no deleterious side effects. When added into a molten mixture of the polymers, the additive assists in driving out entrapped air or other gasses, thereby reducing the incidence of occluded air in the composition. The powder also makes the solid more rigid, i.e. more stiff with increased hardness. Air or other gas bubbles in the coating will provide gaps for ingress of moisture and absorption into the composite. It has been found that certain metals and metal oxides provide the function of air exclusion. It is theorized, without being bound, that as the outer layer on a mass of the composition rapidly cools, it applies pressure to subsurface materials thereby driving out any included air. The same function is expected if the composition were to be prepared under gasses other than air.

In order to perform its function, the powder is preferably within a certain size range, which may be dependent upon the nature of the powder. Thus, for example, powdered aluminum, one of the preferred powders, is preferably sized so that the bulk of the particles are in the size range 25 to 60 microns. On the other hand, titanium oxide, also a preferred powder is preferably in the size range of up to 1 micron.

The quantity of powder to be added depends to some extent upon the nature of the polymer mixture and the type of powder. However, in general, the amount of powder, based upon the weight of the polymer mixture and the powder, is from about 5 to about 15 wt. %, and most preferably about 10 wt. %.

A variety of powdered materials may be used to perform the functions described herein. While the most preferred powders are aluminum and titanium oxide, other like powders might also be expected to function well in the compositions of the invention. Examples include, but are not limited to aluminum oxide, silicon dioxide, zirconium dioxide, titanium carbide, and silicon carbide.

A method of preparing an embodiment of the composition according to the invention includes selecting suitable amounts of the fatty acid esters and paraffins for the mixture, and heating the mixture to its melting point to produce a liquid. A predetermined amount of powder of a selected type is added to the liquid hydrocarbon, and mixed in while minimizing air entrainment into the liquid mass. After mixing, the liquid mixture is rapidly cooled, for example by placing into a cold freezer or refrigerator preferably at or near about 32° F. (0° C.). During cooling, the solidification of the outer surfaces of the mixture mass, and its contraction, compresses the interior portion, and expels any entrained air. The solidified mass is then preferably pulverized for ease of subsequent use to coat a substrate, such as a composite structure.

The coating of the invention may be applied by any of a variety of conventional techniques. Preferably, no solvent is added to the composition because solvents produce volatile organic compounds (“VOCs”) into the atmosphere when they evaporate, and are therefore environmentally objectionable. Further, even if drying of a coating with solvent added were in a controlled environment where VOCs were captured, solvent evaporation could produce pinholes in the resulting coating. Accordingly adding solvent is disfavored. The composition is preferably applied solvent free. If it is liquefied by heating, it can be applied by spraying, brushing on or applying with rollers, or any other conventional means of coating application.

Coating thickness may vary depending upon the nature of the composite substrate, the conditions to which the coated substrate will be exposed, and the particular polymer mixture used in the coating composition. Coating thickness will also vary based on the method of application. In general, however, a coating thickness of at least about 0.05 mm would be suitable for most applications. It is noted that the coating itself does not gain weight (i.e. moisture) upon exposure of coating material by itself to hot and humid ambient conditions.

In solid form, the composition is waxy, and the addition of titanium oxide as a powdered additive causes its color to be white. This permits application of a colored coating to the composite substrate which may be advantageous in certain applications. Of course, other coloring additives may be added as well, if desired. The use of metallic powder, on the other hand, provides a metallic appearance. Thus, aluminum powder results in a composition that has an aluminum metallic sheen.

The coating composition is chemically stable, and nonreactive with composite substrate materials. Accordingly, it may be applied on a wide range of composite substrate materials, and indeed, on other materials as well to minimize or prevent moisture absorption. The coating may be removed by a variety of means, for example, by dissolving it with suitable chemicals, such as detergents or solvents, or by mechanical scraping off and polishing with a suitable brush or other instrument, or by applying heat to melt the coating and wiping it off, or by a combination of these methods.

The compositions of the invention will provide protection against moisture absorption effective for long periods of time, if the coatings are not subject to processes that damage or remove them. The coatings can be repaired if damaged or reapplied, from time to time, as needed to maintain the moisture incursion barrier they provide.

The following example illustrates aspects of the invention described herein and does not limit the scope of the invention.

### EXAMPLES

### Example 1

Tests were conducted, on a composite core material, to compare the efficacy of coating compositions in accordance with the invention with a commercially available coating material also intended to prevent moisture absorption, and with a control sample that was not coated.

A total of three specimens of a composite core material, ROHACELL™ (trademark of ROHM, GMBH of Germany) foam, were prepared: specimen A was coated with a coating in accordance with the invention; specimen B was coated with CORLAR (a trademark of DuPont Company of Delaware) coating; and specimen C was uncoated. The specimens were identical, except for their coating status, and each measured 2 in.×4 in.×0.5 in. Each specimen was taken from the same sample of ROHACELL foam, and each was dried and weighed to obtain an initial dry weight.

A batch of a coating composition in accordance with the invention was prepared by mixing 60 parts by weight of yellow beeswax with 40 parts by weight of paraffin wax and heating to 180° F. (82° C.) to melt these ingredients. Once the mixture was liquefied, 10 parts by weight powdered aluminum was added. The mixture was then rapidly cooled by placing it in a freezer. The solid composition obtained was pulverized to facilitate use as a coating. A sample of the pulverized mass was heated to liquefaction to allow it to be brushed or “painted” onto specimens.

Specimen A was coated with the inventive mixture by brushing a coating of the liquefied mixture onto each exposed surface. Specimen B was coated with CORLAR™. Each of specimens A, B and C were weighed.

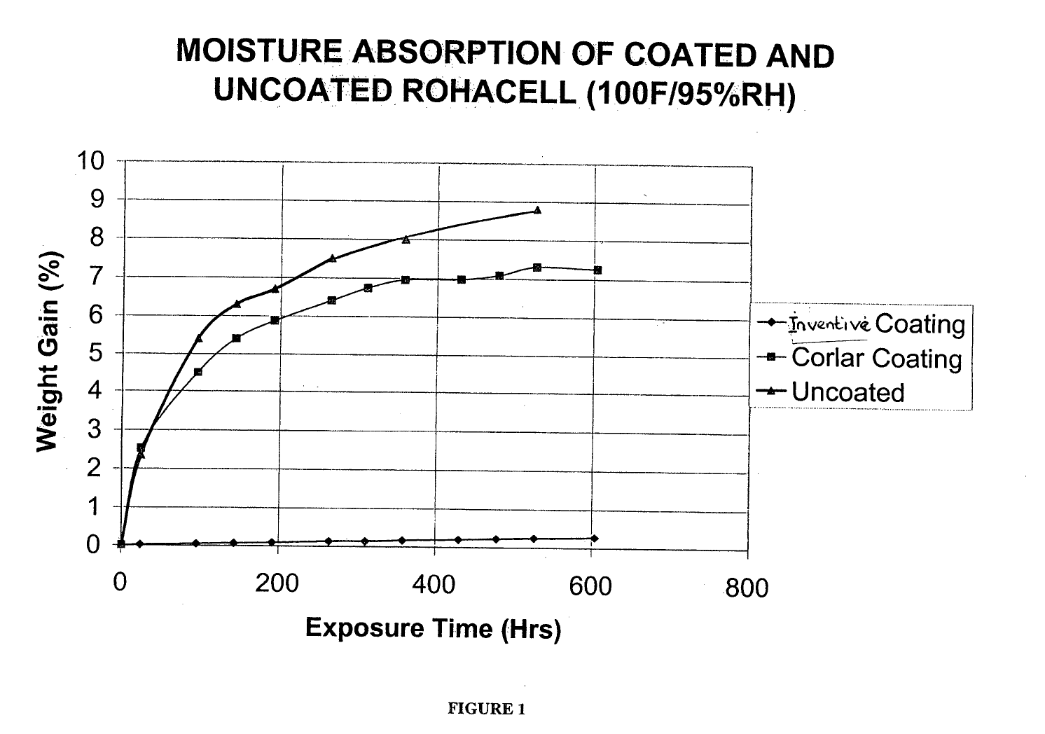

The test specimens were then placed in a chamber maintained at 100 F. (38 C) and 95% relative humidity. At periodic intervals, the samples were quickly removed, cooled for a few minutes, weighed, and replaced in the chamber. For each sample the weight gain was calculated at each time period as a percentage of the initial weight. The percent weight gain was then determined for each specimen, and plotted against time (since commencement of insertion into the chamber), to yield the curves shown in FIG. 1.

From FIG. 1, it is apparent that the percent weight (moisture) gain of the uncoated and CORLAR™ coated specimen had initially experienced similar weight gain, but after about 100 hours, the uncoated specimen's moisture gain exceeded that of the CORLAR™ coated specimen. At 500 hours, the uncoated specimen had gained about 8.8% moisture, and the CORLAR™ coated specimen had gained about 7.3%. In sharp contrast, the specimen coated with the invention had gained about 0.2% moisture. This represents a significant decrease of about 97.7% in moisture gain relative to the uncoated specimen, and about 97.3% relative to the CORLAR™ coated specimen.

### Example 2

A similar test to that of Example 1 above was conducted to determine the efficacy of the coating composition in preventing moisture absorption into a graphite/epoxy outer layer taken from a sandwich composite structure, as compared to CORLAR™ coating or no coating at all.

Again, three specimens were prepared this time each selected from the graphite epoxy composite layer, and each of identical size. One specimen was coated with the composition of the invention, in Example 1 above and another with CORLAR™. The last was not coated.

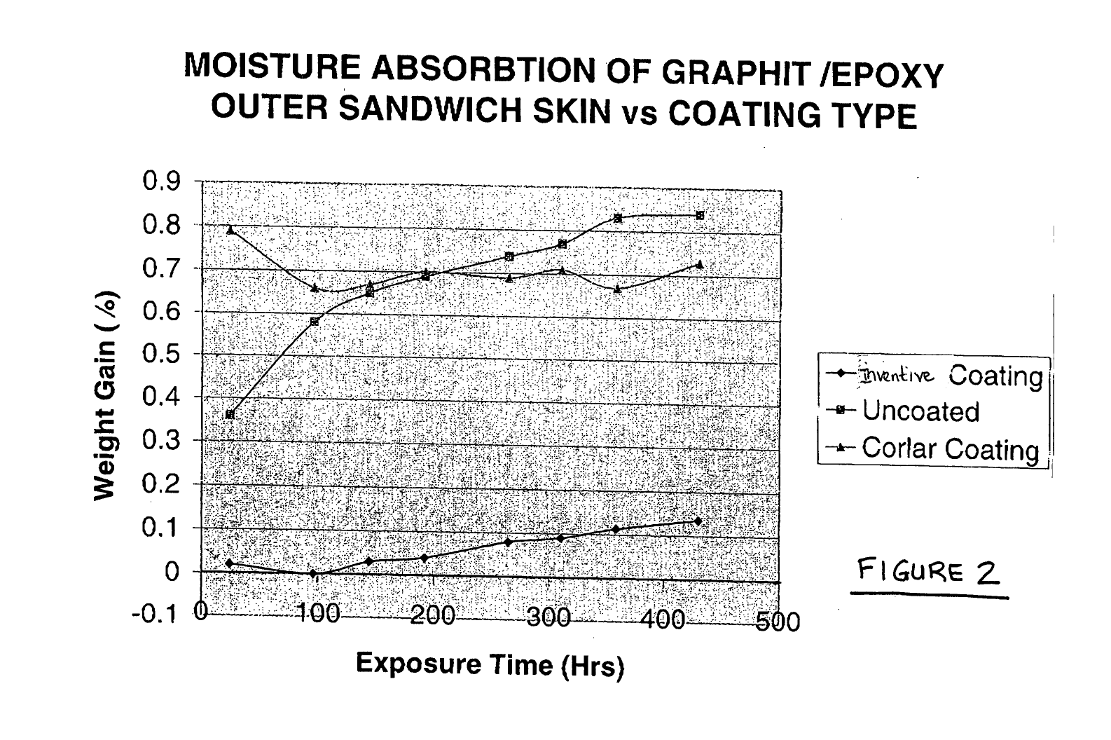

Following the procedure of Example 1, weight gain of each specimen in the chamber was determined at preset intervals. The moisture gain was calculated as a percentage and plotted against time for each specimen to obtain the graph of FIG. 2.

After about 400 hours, the uncoated control specimen had gained over 0.84% moisture, while the CORLAR™ coated specimen had gained 0.7%. In contrast, the specimen having the inventive coating only gained about 0.12%.

From these tests, it can be concluded that the inventive coating reduces moisture absorption by the epoxy/graphite composite by about 85% relative to an uncoated composite and 83% relative to a CORLAR™ coated composite.

The above description of embodiments of the invention is not limiting of the invention as encompassed in the claims here below. Any modifications to the described invention, that may be obvious to a person of skill in the art, are encompassed within the scope of equivalents of the claimed invention.

1. A coating composition for resisting moisture penetration into a substrate coated with the coating, the coating composition comprising:
a) a mixture comprising waxes and paraffins; and
b) a powdered metal, metal oxide, or metal carbide dispersed throughout the mixture;
wherein the coating reduces moisture gain by a substrate coated therewith by at least about 50% as compared to an uncoated substrate under the same temperature and moisture conditions.

2. The coating composition of claim 1, wherein the mixture comprises a mixture of beeswax and paraffins.

3. The coating composition of claim 2, wherein the paraffins comprise primarily aliphatic hydrocarbons having chain lengths in the range from about 18 to about 36 carbon atoms.

4. The coating composition of claim 1, wherein the metal comprises aluminum.

5. The coating composition of claim 1, wherein the metal oxide comprises titanium oxide or aluminum oxide.

6. The coating composition of claim 2, wherein the metal comprises aluminum.

7. The coating composition of claim 2, wherein the metal oxide comprises titanium oxide or aluminum oxide.

8. The coating composition of claim 1, wherein the mixture, before addition of powdered metal or metal oxide, has a melting point in the range of about 120 to 200° F.

9. The coating composition of claim 1, wherein, the composition cools to ambient temperature substantially free of occlusion of gas bubbles.

10. The coating composition of claim 1, wherein the composition is a solid at temperatures in the range below about 140° F., and liquefies upon heating to a temperature in the range from about 170 to about 190° F.

11. The coating composition of claim 10, wherein physical properties of the liquefied composition enable application of the composition to a surface by spraying, painting with a brush or roller.

12. The coating composition of claim 1, wherein the powdered metal or metal oxide or metal carbide comprises a sufficient amount to permit uniform heating of a mass of the composition, and to provide such internal compression of a mass of the composition upon cooling as to substantially exclude occluded gasses from a cooled mass.

13. The coating composition of claim 1, wherein the amount of powdered metal or metal oxide comprises from about 5 to about 15 wt. %, based on the weight of the polymeric mixture.

14. The coating composition of claim 1, wherein when coated onto a composite material subject to moisture absorption under hot and wet ambient conditions, the composition reduces moisture absorption by from about 60 to about 100% as compared to an uncoated composite.

15. A coating composition resistant to penetration by moisture, the composition substantially preventing moisture absorption into a composite otherwise subject to moisture absorption under hot and wet ambient conditions, the composition comprising:
a) a mixture of esters of fatty acids and aliphatic hydrocarbons having a melting point in the range from about 170 to about 190° F.; and
b) a powdered additive in sufficient amount to permit uniform heating of a mass of the composition and to provide compression of a mass of the composition upon cooling sufficient to substantially exclude occluded gasses from a cooled mass.

16. The coating composition of claim 14, wherein the mixture comprises paraffins and waxes, the paraffins primarily having a chain length of from about 18 to about 36 carbon atoms.

17. The coating composition of claim 15, wherein the powdered additive is selected from the group consisting of powdered metals, metal carbides and metal oxides.

18. The coating composition of claim 16, wherein the powdered additive comprises powdered aluminum comprising particulates in the range from about 25 to about 60 microns.

19. The coating composition of claim 17, wherein the powdered additive is selected from aluminum and titanium oxide.

20. The coating composition of claim 14, the composition comprising a solid at ambient temperatures in the range below about 140° F.

21. The coating composition of claim 14, wherein when coated onto a composite material subject to moisture absorption under ambient conditions of temperature and humidity, the composition reduces moisture absorption by from about 60 to about 100%.
